SEQUENCE LISTING (5 sequences)

SEQ ID NO: 1 - protein, 573 aa, Myceliophthora thermophila
QQSCNTPSNRACWTDGYDINTDYEVDSPDTGVVRPYTLTLTEVDNWTGPDGVVKEKVMLVNNSIIGPTIFADWGDTIQVTVINNLETNGTSIHWHGLHQKGTNLHDGANGITECPIPPKGGRKVYRFKAQQYGTSWYHSHFSAQYGNGVVGAIQINGPASLPYDTDLGVFPISDYYYSSADELVELTKNSGAPFSDNVLFNGTAKHPETGEGEYANVTLTPGRRHRLRLINTSVENHFQVSLVNHTMCIIAADMVPVNAMTVDSLFLGVGQRYDVVIEANRTPGNYWFNVTFGGGLLCGGSRNPYPAAIFHYAGAPGGPPTDEGKAPVDHNCLDLPNLKPVVARDVPLSGFAKRADNTLDVTLDTTGTPLFVWKVNGSAINIDWGRAVVDYVLTQNTSFPPGYNIVEVNGADQWSYWLIENDPGAPFTLPHPMHLHGHDFYVLGRSPDESPASNERHVFDPARDAGLLSGANPVRRDVSMLPAFGWVVLSFRADNPGAWLFHCHIAWHVSGGLGVVYLERADDLRGAVSDADADDLDRLCADWRRYWPTNPYPKSDSGLKHRWVEEGEWLVKA

SEQ ID NO: 2 - protein, 521 aa, Coprinopsis cinerea
QIVNSVDTMTLTNANVSPDGFTRAGILVNGVHGPLIRGGKNDNFELNVVNDLDNPTMLRPTSIHWHGLFQRGTNWADGADGVNQCPISPGHAFLYKFTPAGHAGTFWYHSHFGTQYCDGLRGPMVIYDDNDPHAALYDEDDENTIITLADWYHIPAPSIQGAAQPDATLINGKGRYVGGPAAELSIVNVEQGKKYRMRLISLSCDPNWQFSIDGHELTIIEVDGQLTEPHTVDRLQIFTGQRYSFVLDANQPVDNYWIRAQPNKGRNGLAGTFANGVNSAILRYAGAANADPTTSANPNPAQLNEADLHALIDPAAPGIPTPGAADVNLRFQLGFSGGRFTINGTAYESPSVPTLLQIMSGAQSANDLLPAGSVYELPRNQVVELVVPAGVLGGPHPFHLHGHAFSVVRSAGSSTYNFVNPVKRDVVSLGVTGDEVTIRFVTDNPGPWFFHCHIEFHLMNGLAIVFAEDMANTVDANNPPVEWAQLCEIYDDLPPEATSIQTVVRRAEPTGFSAKFRREGL

SEQ ID NO: 3 - protein, 343 aa, Coprinopsis cinerea
QGPGGGGSVTCPGGQSTSNSQCCVWFDVLDDLQTNFYQGSKCESPVRKILRIVFHDAIGFSPALTAAGQFGGGGADGSIIAHSNIELAFPANGGLTDTVEALRAVGINHGVSFGDLIQFATAVGMSNCPGSPRLEFLTGRSNSSQPSPPSLIPGPGNTVTAILDRMGDAGFSPDEVVDLLAAHSLASQEGLNSAIFRSPLDSTPQVFDTQFYIETLLKGTTQPGPSLGFAEELSPFPGEFRMRSDALLARDSRTACRWQSMTSSNEVMGQRYRAAMAKMSVLGFDRNALTDCSDVIPSAVSNNAAPVIPGGLTVDDIEVSCPSEPFPEIATASGPLPSLAPAP

SEQ ID NO: 4 - protein, 305 aa, Armoracia rusticana
QLNATFYSGTCPNASAIVRSTIQQAFQSDTRIGASLIRLHFHDCFVDGCDASILLDDSGSIQSEKNAGPNANSARGFNVVDNIKTALENTCPGVVSCSDILALASEASVSLTGGPSWTVLLGRRDSLTANLAGANSAIPSPFEGLSNITSKFSAVGLNTNDLVALSGAHTFGRARCGVFNNRLFNFSGTNGPDPTLNSTLLSSLQQLCPQNGSASTITNLDLSTPDAFDNNYFANLQSNNGLLQSDQELFSTLGSATIAVVTSFASNQTLFFQAFAQSMINMGNISPLTGSNGEIRLDCKKVDGS

SEQ ID NO: 5 - protein, 326 aa, Glycine max
QLTPTFYRETCPNLFPIVFGVIFDASFTDPRIGASLMRLHFHDCFVQGCDGSVLLNNTDTIESEQDALPNINSIRGLDVVNDIKTAVENSCPDTVSCADILAIAAEIASVLGGGPGWPVPLGRRDSLTANRTLANQNLPAPFFNLTQLKASFAVQGLNTLDLVTLSGGHTFGRARCSTFINRLYNFSNTGNPDPTLNTTYLEVLRARCPQNATGDNLTNLDLSTPDQFDNRYYSNLLQLNGLLQSDQELFSTPGADTIPIVNSFSSNQNTFFSNFRVSMIKMGNIGVLTGDEGEIRLQCNFVNGDSFGLASVASKDAKQKLVAQSK

(19) United States
(12) Patent Application Publication
(10) Pub. No.: US 2013/0193071 A1
(43) Pub. Date: Aug. 1, 2013

(54) REMOVAL OF SELENOCYANATE OR SELENITE FROM AQUEOUS SOLUTIONS

(71) Applicants: Gregory Clark DeLozier, Copenhagen Oe (DK); Henrik Lund, Vaerloese (DK)

(72) Inventors: Gregory Clark DeLozier, Copenhagen Oe (DK); Henrik Lund, Vaerloese (DK)

(73) Assignee: NOVOZYMES AVS, Bagsvaerd (DK)

(21) Appl. No.: 13/825,191

(22) PCT Filed: Sep. 21, 2011
(86) PCT No.: PCT/EP11/66407

§ 371 Date: Mar. 20, 2013

(30) Foreign Application Priority Data
Sep. 21, 2010 (EP) 10178117.7

(51) Int. Cl. C02F 3/34

(52) U.S. Cl. CPC C02F 3/342
USPC 210/632

(57) ABSTRACT

The invention relates to a process for removing selenocyanate or selenite from industrial effluents (from hydrocaron processing industry, acid water, flue gas desulpurization) by contacting the aqueous effluent with a phenol oxidizing enzyme (peroxidase, laccase) and suitable oxidizing agent (hydrogen peroxide, oxygen). The method results in formation of elemental selenium, a Se (VI) salt and/or organoselenium compounds, such as selenate. Use of phenol oxidizing enzyme for removing slenocyanate or selenite from an aqueous solution.

### TECHNICAL FIELD

The present invention relates to removal of selenium species, such as selenocyanate and selenium oxyanions, from aqueous solutions, such as effluents or waste water.

### BACKGROUND ART

Selenium is a metalloid element with a well documented impact upon the environment and health. Selenium cycles naturally within the environment however the balances can be significantly disrupted and influenced by anthropogenic activities including mining, minerals processing, agriculture, petroleum refining and coal-based power generation. Consequently, selenium levels within surface and groundwater are rapidly gaining global attention due to an established link between certain selenium species and environmental detriments including bioaccumulation and reproductive abnormalities within waterfowl and fish. To this end, industries that tend to generate significant levels of the most toxic of the selenium species, selenocyanate, selenite and/or selenate, must take steps to ensure that their effluents meet permissible release standards. Of the technologies currently available, co-precipitation of selenium with metals (e.g. iron, copper, aluminum, etc.) and adsorption onto solid supports (e.g. activated carbon, water treatment residuals, etc.) appear to be the most common. However, potential drawbacks of these techniques include preferential applicability to select selenium species, the production of large volumes of sludge that must often be treated according to toxic disposal procedure and/or a general inability to meet the extremely low permissible limits being enacted by global environmental authorities.

Alternative techniques to remove selenium from industrial effluents include both biological and chemical strategies. The use of select microorganisms, operating in a self-contained, customized environment, to reduce selenium species to oxidation states that are non-toxic and/or are amenable to subsequent separation via conventional techniques is gaining momentum. However, these microorganism-based solutions may require a supplemental source of nutrients and are performance-sensitive to molecular oxygen, toxic metals (e.g. As and Hg) and compounds (e.g. phenol) within the incoming feed stream. Interestingly, a potential solution to this problem, the use of enzymes contained within the cell-free extracts of microorganisms associated with these systems, was shown to reduce selenium in the presence of toxic metals.

In nature, selenium exists in −2, 0, +4 and +6 oxidation states. Inorganic species considered toxic include selenite [SeO₃⁻² or Se (IV)], selenate [SeO₄⁻² or Se (VI)] and selenocyanate [SeCN—]. Selenocyanate is generally formed during the processing of fossil feed stocks containing selenium (e.g. seleniferous crudes, shales and coals). All of these species are extremely stable within aqueous environments and, on average, must be reduced to trace levels in industrial effluents prior to release. While selenite is amenable to removal via conventional co-precipitation, the remaining two species are relatively recalcitrant towards the most prevalent precipitation technologies. A means to offer or extend conventional treatment to contend with at least one of these species, selenocyanate, would, therefore, be of great interest to the hydrocarbon processing, coal-based power, agriculture and mining industries.

The present invention may offer a means to address soluble selenium species within industrial effluents and does not require significant capital investment, can integrate into existing operations, enable emerging selenium removal technologies (e.g. ABMet), does not generate a problematic by-product, can address certain recalcitrant species (i.e. selenocyanate), and/or performs removal of other compounds (e.g. phenol, aniline, cresol, xylenol, etc.) in parallel with selenium removal.

While not inclusive, specific advantages of the present invention include: 1. A biochemical route to selenium mitigation that is not inhibited in the presence of toxic compounds (e.g. phenol, cresol, aniline, etc.) or metals (e.g. Hg, As, Cr); 2. A selenium mitigating technology that employs substrates inherently present within most effluents derived from the hydrocarbon-processing and coal-based power industries; 3. A novel technology with potential synergies and/or which enables one or more of the commercial and emerging techniques used for heteroatom (e.g. Se, As, Hg, Cr, etc.) mitigation in industrial effluents (e.g. metal co-precipitation, ion exchange, membrane filtration, biological treatment including constructed wet-lands).

### SUMMARY OF THE INVENTION

The present inventors surprisingly found that selenocyanate and/or selenite, can be removed from an aqueous solution containing such selenocyanate and/or selenite, for example an effluent or waste water, by contacting the aqueous solution with a phenol oxidizing enzyme and an oxidizing agent. In an embodiment, the aqueous solution containing the selenocyanate and/or selenite is also contacted with one or more oxidizable substrates acting as electron donors and/or acceptors for the phenol oxidizing enzyme, such as one or more phenols or polyphenols.

### DETAILED DESCRIPTION OF THE INVENTION

### Phenol Oxidizing Enzyme

In the context of the present invention, the phenol oxidizing enzyme may be a peroxidase or a laccase enzyme. Phenol oxidizing enzymes are used in the presence of an oxidizing agent.

When the phenol oxidizing enzyme is a laccase, the oxidizing agent is oxygen (or a source of oxygen). Laccase and oxygen (or a source of oxygen) may be referred to as a laccase system.

When the phenol oxidizing enzyme is peroxidase, the oxidizing agent is hydrogen peroxide (or a source of hydrogen peroxide). Peroxidase and hydrogen peroxide (or a source of hydrogen peroxide) may be referred to as a peroxidase system.

The enzyme of the invention may typically be present in concentrations of from 1 μg to 100 mg enzyme protein per liter aqueous solution, preferably of from 5 μg to 50 mg enzyme protein per liter aqueous solution, more preferably of from 10 μg to 25 mg enzyme protein per liter aqueous solution, more preferably of from 10 μg to 10 mg enzyme protein per liter aqueous solution, more preferably of from 50 μg to 10 mg enzyme protein per liter aqueous solution, and most preferably of from 50 μg to 5 mg enzyme protein per liter aqueous solution.

In further particular embodiments of the method of the invention, the phenol oxidizing enzyme is used in an amount of 0.005-50 ppm (mg/I), or 0.01-40, 0.02-30, 0.03-25, 0.04-20, 0.05-15, 0.05-10, 0.05-5, 0.05-1, 0.05-0.8, 0.05-0.6, or 0.1-0.5 ppm. The amount of enzyme refers to mg of enzyme protein.

In the method of the invention, the phenol oxidizing enzyme may be applied alone or together with an additional enzyme. The term “an additional enzyme” means at least one additional enzyme, e.g. one, two, three, four, five, six, seven, eight, nine, ten or even more additional enzymes.

The term “applied together with” (or “used together with”) means that the additional enzyme may be applied in the same, or in another step of the process of the invention. The other process step may be upstream or downstream in the complete process, as compared to the step in which the selenocyanate and/or selenite are removed with the phenol oxidizing enzyme.

In particular embodiments the additional enzyme is an enzyme which has protease, lipase, xylanase, cutinase, cellulase, endoglucanase, amylase, mannanase, steryl esterase, and/or cholesterol esterase activity.

The term “a step” of a process means at least one step, and it could be one, two, three, four, five or even more process steps. In other words the phenol oxidizing enzyme of the invention may be applied in at least one process step, and the additional enzyme(s) may also be applied in at least one process step, which may be the same or a different process step as compared to the step where the phenol oxidizing enzyme is used.

The term “enzyme preparation” means a product containing at least one phenol oxidizing enzyme. The enzyme preparation may also comprise enzymes having other enzyme activities. In addition to the enzymatic activity such a preparation preferably contains at least one adjuvant. Examples of adjuvants, which are used in enzyme preparations are buffers, polymers, surfactants and stabilizing agents.

In the present context, whenever a phenol oxidizing enzyme is mentioned that requires or benefits from the presence of acceptors (e.g. oxygen or hydrogen peroxide), enhancers, mediators and/or activators, such compounds should be considered to be included. Examples of enhancers and mediators are disclosed in EP 705327; WO 98/56899; EP 677102; EP 781328; and EP 707637. If desired a distinction could be made by defining a phenol oxidizing enzyme system (e.g. a laccase, or a peroxidase enzyme system) as the combination of the enzyme in question and its acceptor, and optionally also an enhancer and/or mediator for the enzyme in question.

### Laccase

A laccase according to the invention is any laccase enzyme comprised by the enzyme classification EC 1.10.3.2 as set out by the Nomenclature Committee of the International Union of Biochemistry and Molecular Biology (IUBMB), or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea or Myceliophthora thermophila. Preferably, the amino acid sequence of the laccase has at least 80% identity, more preferably at least 85%, more preferably at least 90%, more preferably at least 95%, and most preferably 100% identity to the Myceliophthora thermophila laccase shown as SEQ ID NO:1, or the Coprinopsis cinerea laccase shown as SEQ ID NO:2.

The laccase enzyme may furthermore be one which is producible by a method comprising cultivating a host cell transformed with a recombinant DNA vector which carries a DNA sequence encoding said laccase as well as DNA sequences encoding functions permitting the expression of the DNA sequence encoding the laccase, in a culture medium under conditions permitting the expression of the laccase enzyme, and recovering the laccase from the culture.

In further particular embodiments of the method and use of the invention, the laccase and/or compound exhibiting laccase activity is used in an amount of 0.005-50 ppm (mg/l), or 0.01-40, 0.02-30, 0.03-25, 0.04-20, 0.05-15, 0.05-10, 0.05-5, 0.05-1, 0.05-0.8, 0.05-0.6, or 0.1-0.5 ppm. The amount of enzyme refers to mg of enzyme protein.

### Determination of Laccase Activity (LAMU)

Laccase activity may be determined from the oxidation of syringaldazine under aerobic conditions. The violet colour produced is measured at 530 nm. The analytical conditions are 19 mM syringaldazine, 23 mM Tris/maleate buffer, pH 7.5, 30° C., 1 min. reaction time. One laccase unit (LAMU) is the amount of enzyme that catalyses the conversion of 1.0 mmole syringaldazine per minute at these conditions.

### Source of Oxygen

The source of oxygen required by the laccase may be oxygen from the atmosphere or an oxygen precursor for in situ production of oxygen. In many industrial applications, oxygen from the atmosphere will usually be present in sufficient quantity. If more O₂ is needed, additional oxygen may be added, e.g. as pressurized atmospheric air or as pure pressurized O₂. Alternatively, oxygen precursors such as peroxides may be inherently present and/or added to the effluent and which, upon dissociation or reduction, provide an in situ source of oxygen. Suitable peroxides may be provided as described below.

### Peroxidase

A peroxidase according to the invention is a peroxidase enzyme comprised by the enzyme classification EC 1.11.1.7, or any fragment derived therefrom, exhibiting peroxidase activity.

Preferably, the peroxidase according to the invention is producible by plants (e.g. horseradish peroxidase (see SEQ ID NO:4) or soybean peroxidase (see SEQ ID NO:5)) or microorganisms such as fungi or bacteria. In an embodiment, the amino acid sequence of the peroxidase at least 80% identity, more preferably at least 85%, more preferably at least 90%, more preferably at least 95%, and most preferably 100% identity to the soybean peroxidase shown as SEQ ID NO:5, or the horseradish peroxidase shown as SEQ ID NO:4.

Some preferred fungi include strains belonging to the subdivision Deuteromycotina, class Hyphomycetes, e.g., Fusarium, Humicola, Tricoderma, Myrothecium, Verticillum, Arthromyces, Caldariomyces, Ulocladium, Embellisia, Cladosporium or Dreschlera, in particular Fusarium oxysporum (DSM 2672), Humicola insolens, Trichoderma resii, Myrothecium verrucaria (IFO 6113), Verticillum alboatrum, Verticillum dahlie, Arthromyces ramosus (FERM P-7754), Caldariomyces fumago, Ulocladium chartarum, Embellisia alli or Dreschlera halodes.

Other preferred fungi include strains belonging to the subdivision Basidiomycotina, class Basidiomycetes, e.g., Coprinopsis, Phanerochaete, Coriolus or Trametes, in particular Coprinopsis cinerea f. microsporus (IFO 8371), Coprinopsis macrorhizus, Phanerochaete chrysosporium (e.g. NA-12) or Trametes (previously called Polyporus), e.g., T. versicolor (e.g. PR4 28-A).

Further preferred fungi include strains belonging to the subdivision Zygomycotina, class Mycoraceae, e.g., Rhizopus or Mucor, in particular Mucor hiemalis.

Some preferred bacteria include strains of the order Actinomycetales, e.g. Streptomyces spheroides (ATTC 23965), Streptomyces thermoviolaceus (IFO 12382) or Streptoverticillum verticillium ssp. verticillium.

Other preferred bacteria include Rhodobacter sphaeroides, Rhodomonas palustri, Streptococcus lactis, Pseudomonas purrocinia (ATCC 15958), Pseudomonas fluorescens (NRRL B-11) and Bacillus strains, e.g. Bacillus pumilus (ATCC 12905) and Bacillus stearothermophilus.

Further preferred bacteria include strains belonging to Myxococcus, e.g., M. virescens.

The peroxidase may furthermore be one which is producible by a method comprising cultivating a host cell transformed with a recombinant DNA vector which carries a DNA sequence encoding said peroxidase as well as DNA sequences encoding functions permitting the expression of the DNA sequence encoding the peroxidase, in a culture medium under conditions permitting the expression of the peroxidase and recovering the peroxidase from the culture.

Particularly, a recombinantly produced peroxidase is a peroxidase derived from a Coprinus sp. (also referred to as Coprinopsis sp.), in particular C. macrorhizus or C. cinereus (see e.g. SEQ ID NO:3).

In the context of this invention, compounds possessing peroxidase activity comprise peroxidase enzymes and peroxidase active fragments derived from cytochromes, haemoglobin or peroxidase enzymes.

### Determination of Peroxidase Activity (PDXU)

One peroxidase unit (PDXU) is the amount of enzyme which catalyzes the conversion of one pmole hydrogen peroxide per minute at 30° C. in a mixture containing:
0.1 M phosphate buffer, pH 7.0;
0.88 mM hydrogen peroxide; and
1.67 mM 2,2′-azino-bis(3-ethylbenzothiazoline-6-sulfonate) (ABTS).

The reaction is continued for 60 seconds (15 seconds after mixing) while the change in absorbance at 418 nm is measure. The absorbance should be in the range of 0.15 to 0.30. In the calculation of peroxidase activity is used an absorption coefficient of oxidized ABTS of 36 mM⁻¹ cm⁻¹ and a stoichiometry of one pmole H₂O₂ converted per two pmole ABTS oxidized.

### Source of Hydrogen Peroxide

The source of hydrogen peroxide required by the peroxidase, or compounds exhibiting peroxidase activity, may be provided as an aqueous solution of hydrogen peroxide or a hydrogen peroxide precursor for in situ production of hydrogen peroxide. Any solid entity which liberates upon dissolution a peroxide which is useable by peroxidase can serve as a source of hydrogen peroxide. Compounds which yield hydrogen peroxide upon dissolution in water or an appropriate aqueous based medium include but are not limited to metal peroxides, percarbonates, persulphates, perphosphates, peroxyacids, alkyperoxides, acylperoxides, peroxyesters, urea peroxide, perborates and peroxycarboxylic acids or salts thereof.

Another source of hydrogen peroxide is a hydrogen peroxide generating enzyme system, such as an oxidase together with a substrate for the oxidase. Examples of combinations of oxidase and substrate comprise, but are not limited to, amino acid oxidase (see e.g. U.S. Pat. No. 6,248,575) and a suitable amino acid, glucose oxidase (see e.g. WO 95/29996) and glucose, lactate oxidase and lactate, galactose oxidase (see e.g. WO 00/50606) and galactose, and aldose oxidase (see e.g. WO 99/31990) and a suitable aldose.

By studying EC 1.1.3._, EC 1.2.3._, EC 1.4.3._, and EC 1.5.3._{—} or similar classes (under the International Union of Biochemistry), other examples of such combinations of oxidases and substrates are easily recognized by one skilled in the art.

Hydrogen peroxide or a source of hydrogen peroxide may be added at the beginning of or during the process, e.g., typically in an amount corresponding to levels of from 0.001 mM to 25 mM, preferably to levels of from 0.005 mM to 5 mM, and particularly to levels of from 0.01 to 1 mM hydrogen peroxide. Hydrogen peroxide may also be used in an amount corresponding to levels of from 0.1 mM to 25 mM, preferably to levels of from 0.5 mM to 15 mM, more preferably to levels of from 1 mM to 10 mM, and most preferably to levels of from 2 mM to 8 mM hydrogen peroxide.

### Oxidizable Substrates

The oxidizable substrates according to the invention act as electron donors and/or acceptors for the phenol oxidizing enzyme (able to participate in reductive and/or oxidative electron transfer reactions with the phenol oxidizing enzyme). Preferable, the oxidizable substrates act as electron donors for the phenol oxidizing enzyme.

Examples of oxidizable substrates are phenols and polyphenols.

Phenols, sometimes called phenolics, are a class of chemical compounds consisting of a hydroxyl group (—OH) bonded directly to an aromatic hydrocarbon group. The simplest of the class is phenol. Phenols can have two or more hydroxy groups bonded to the aromatic ring(s) in the same molecule. The simplest examples are the three benzenediols, each having two hydroxy groups on a benzene ring. Other examples of phenols include ortho-, meta- and para-cresols, xylenol (dimethylphenol), 3-ethylphenol, aniline.

Polyphenols are a structural class of natural, synthetic, and semisynthetic organic chemicals characterized by the presence of large multiples of phenol structural units. Polyphenols are generally moderately water-soluble compounds with molecular weight of 500-4000 Da, more than 12 phenolic hydroxyl groups, and 5-7 aromatic rings per 1000 Da; where the limits to these ranges are somewhat flexible.

Phenols and polyphenols are oxidizable substrates of phenol oxidizing enzymes, such as laccase and peroxidase. Enzymatic oxidation of phenols or polyphenols with laccase or peroxidase can result in a polymerization of these substrates. Other examples of oxidizable substrates according to the invention may be selected from the group consisting of aliphatic, cyclo-aliphatic, heterocyclic or aromatic compounds containing the moiety>N—OH. In a preferred embodiment of the invention the oxidizable substrate is a compound of the general formula I:

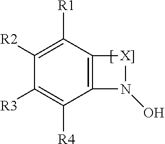

wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof; [X] represents a group selected from (—N═N—), (—N═CR⁶—)ₘ, (—CR⁶═N—)ₘ, (—CR⁷═CR⁸—)ₘ, (—CR⁶═N—NR⁷—), (—N═N—CHR⁶—), (—N═CR⁶−NR⁷—), (—N═CR⁶—CHR⁷—), (—CR⁶═N—CHR⁷—), (—CR⁶═CR⁷—NR⁸—), and (—CR⁶═CR⁷—CHR⁸—), wherein R⁶, R⁷, and R⁸ independently of each other are selected from H, OH, NH₂, COOH, SO₃H, NO₂, CN, Cl, Br, F, CH₂OCH₃, OCH₃, and COOCH₃; and m is 1 or 2.

The term “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

In a more preferred embodiment of the invention the oxidizable substrate is a compound of the general formula II:

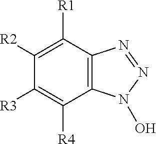

wherein R¹, R², R³, R⁴ are individually selected from the group consisting of hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof, wherein the R¹, R², R³, R⁴ may be substituted with R⁵, wherein R⁵ represents hydrogen, halogen, hydroxy, formyl, carboxy and salts and esters thereof, amino, nitro, C₁₋₁₂-alkyl, C₁₋₆-alkoxy, carbonyl(C₁₋₁₂-alkyl), aryl, in particular phenyl, sulfo, aminosulfonyl, carbamoyl, phosphono, phosphonooxy, and salts and esters thereof.

The oxidizable substrate may also be a salt or an ester of formula I or II.

Further preferred oxidizable substrates are oxoderivatives and N-hydroxy derivatives of heterocyclic compounds and oximes of oxo- and formyl-derivatives of heterocyclic compounds, said heterocyclic compounds including five-membered nitrogen-containing heterocycles, in particular pyrrol, pyrazole and imidazole and their hydrogenated counterparts (e.g. pyrrolidine) as well as triazoles, such as 1,2,4-triazole; six-membered nitrogen-containing heterocycles, in particular mono-, di- and triazinanes (such as piperidine and piperazine), morpholine and their unsaturated counterparts (e.g. pyridine and pyrimidine); and condensed heterocycles containing the above heterocycles as substructures, e.g. indole, benzothiazole, quinoline and benzoazepine.

Examples of preferred oxidizable substrates from these classes of compounds are pyridine aldoximes; N-hydroxypyrrolidinediones such as N-hydroxysuccinimide and N-hydroxyphthalimide; 3,4-dihydro-3-hydroxybenzo[1,2,3]triazine-4-one; formaldoxime trimer (N,N′,N″-trihydroxy-1,3,5-triazinane); and violuric acid (1,3-diazinane-2,4,5,6-tetrone-5-oxime).

Still further oxidizable substrates, which may be applied in the invention, include oximes of oxo- and formyl-derivatives of aromatic compounds, such as benzoquinone dioxime and salicylaldoxime (2-hydroxybenzaldehyde oxime), and N-hydroxyamides and N-hydroxyanilides, such as N-hydroxyacetanilide.

Preferred oxidizable substrates are selected from the group consisting of 1-hydroxybenzotriazole; 1-hydroxybenzotriazole hydrate; 1-hydroxybenzotriazole sodium salt; 1-hydroxybenzotriazole potassium salt; 1-hydroxybenzotriazole lithium salt; 1-hydroxybenzotriazole ammonium salt; 1-hydroxybenzotriazole calcium salt; 1-hydroxybenzotriazole magnesium salt; and 1-hydroxybenzotriazole-6-sulphonic acid.

A particularly preferred oxidizable substrate is 1-hydroxybenzotriazole.

All the specifications of N-hydroxy compounds above are understood to include tautomeric forms such as N-oxides whenever relevant.

Another preferred group of oxidizable substrates comprises a —CO—NOH— group and has the general formula III:

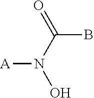

in which A is:

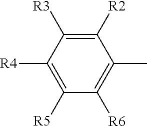

and B is the same as A; or B is H or C₁₋₁₂-alkyl, said alkyl may contain hydroxy, ester or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, acyl, C₁₋₈-alkyl, acyl, NO₂, CN, Cl, Br, F, CF₃, NOH—CO-phenyl, CO—NOH-phenyl, C₁₋₆—CO—NOH—A, CO—NOH—A, COR12, phenyl-CO—NOH—A, OR7, NR8R9, COOR10, or NOH—CO—R11, wherein R7, R8, R9, R10, R11 and R12 are C₁₋₁₂-alkyl or acyl.

R2, R3, R4, R5 and R6 of A are preferably H, OH, NH₂, COOH, SO₃H, C₁₋₃-alkyl, acyl, NO₂, CN, Cl, Br, F, CF₃, NOH-CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of A are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of A are H, OH, COOH, SO₃H, CH₃, acyl, NO₂, CN, Cl, Br, F, CO—NOH-phenyl, OCH₃, COCH₃, or COOCH₃; and in particular R2, R3, R4, R5 and R6 of A are H, OH, COOH, SO₃H, CH₃, NO₂, CN, Cl, Br, CO—NOH-phenyl, or OCH₃.

R2, R3, R4, R5 and R6 of B are preferably H, OH, NH₂, COOH, SO₃H, C₁₋₃-alkyl,acyl, NO₂, CN, Cl, Br, F, CF₃, NOH—CO-phenyl, CO-NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl; more preferably R2, R3, R4, R5 and R6 of B are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃; even more preferably R2, R3, R4, R5 and R6 of B are H, OH, COOH, SO₃H, CH₃, acyl, NO₂, CN, Cl, Br, F, CO-NOH-phenyl, OCH₃, COCH₃, or COOCH₃; and in particular R2, R3, R4, R5 and R6 of B are H, OH, COOH, SO₃H, CH₃, NO₂, CN, Cl, Br, CO—NOH-phenyl, or OCH₃.

B is preferably H or C₁₋₃-alkyl, said alkyl may contain hydroxy, ester or ether groups; preferably said alkyl may contain ester or ether groups; more preferably said alkyl may contain ether groups.

In an embodiment, A and B independently of each other are:

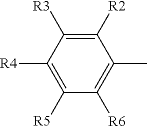

or B is H or C₁₋₃-alkyl, said alkyl may contain hydroxy, ester or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, C₁₋₃-alkyl, acyl, NO₂, CN, Cl, Br, F, CF₃, NOH—CO-phenyl, CO—NOH-phenyl, COR12, OR7, NR8R9, COOR10, or NOH—CO—R11, wherein R7, R8 and R9 are C₁₋₃-alkyl or acyl, and R10, R11 and R12 are C₁₋₃-alkyl.

In another embodiment, A and B independently of each other are:

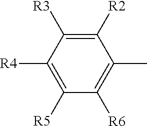

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, NH₂, COOH, SO₃H, CH₃, acyl, NO₂, CN, Cl, Br, F, CF₃, CO—NOH-phenyl, COCH₃, OR7, NR8R9, or COOCH₃, wherein R7, R8 and R9 are CH₃ or COCH₃.

In another embodiment, A and B independently of each other are:

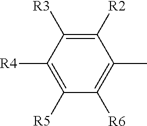

or B is H or C₁₋₃-alkyl, said alkyl may contain hydroxy or ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, acyl, NO₂, CN, Cl, Br, F, CO-NOH-phenyl, OCH₃, COCH₃, or COOCH₃.

In another embodiment, A and B independently of each other are:

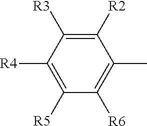

or B is C₁₋₃-alkyl, said alkyl may contain ether groups (e.g. wherein the ether oxygen is directly attached to A—N(OH)C═O—, thus including N-hydroxy carbamic acid ester derivatives), and R2, R3, R4, R5 and R6 independently of each other are H, OH, COOH, SO₃H, CH₃, NO₂, CN, Cl, Br, CO—NOH-phenyl, or OCH₃.

The terms “C₁₋ₙ-alkyl” wherein n can be from 2 through 12, as used herein, represent a branched or straight alkyl group having from one to the specified number of carbon atoms. Typical C₁₋₆-alkyl groups include, but are not limited to, methyl, ethyl, n-propyl, iso-propyl, butyl, iso-butyl, sec-butyl, tert-butyl, pentyl, iso-pentyl, hexyl, iso-hexyl and the like.

The term “acyl” as used herein refers to a monovalent substituent comprising a C₁₋₆-alkyl group linked through a carbonyl group; such as e.g. acetyl, propionyl, butyryl, isobutyryl, pivaloyl, valeryl, and the like.

In an embodiment at least one of the substituents R2, R3, R4, R5 and R6 of A are H, preferably at least two of the substituents R2, R3, R4, R5 and R6 of A are H, more preferably at least three of the substituents R2, R3, R4, R5 and R6 of A are H, most preferably at least four of the substituents R2, R3, R4, R5 and R6 of A are H, in particular all of R2, R3, R4, R5 and R6 of A are H.

In another embodiment at least one of the substituents R2, R3, R4, R5 and R6 of B are H, preferably at least two of the substituents R2, R3, R4, R5 and R6 of B are H, more preferably at least three of the substituents R2, R3, R4, R5 and R6 of B are H, most preferably at least four of the substituents R2, R3, R4, R5 and R6 of B are H, in particular all of R2, R3, R4, R5 and R6 of B are H.

In particular embodiments according to the invention the oxidizable substrate is selected from the group consisting of
4-nitrobenzoic acid-N-hydroxyanilide;
4-methoxybenzoic acid-N-hydroxyanilide;
N, N′-dihydroxy-N, N′-diphenylterephthalamide;
decanoic acid-N-hydroxyanilide;
N-hydroxy-4-cyanoacetanilide;
N-hydroxy-4-acetylacetanilide;
N-hydroxy-4-hydroxyacetanilide;
N-hydroxy-3-(N′-hydroxyacetamide)acetanilide;
4-cyanobenzoic acid-N-hydroxyanilide;
N-hydroxy-4-nitroacetanilide;
N-hydroxyacetanilide;
N-hydroxy-N-phenyl-carbamic acid isopropyl ester;
N-hydroxy-N-phenyl-carbamic acid methyl ester;
N-hydroxy-N-phenyl-carbamic acid phenyl ester;
N-hydroxy-N-phenyl-carbamic acid ethyl ester; and
N-hydroxy-N-(4-cyanophenyl)-carbamic acid methyl ester.

Another group of preferred oxidizable substrates is phenolic compounds (alkylsyringates) of the general formula IV:

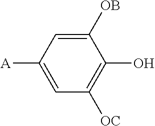

wherein the letter A in said formula denotes be a group such as -D, —CH═CH—D, —CH═CH—CH═CH-D, —CH═N-D, —N═N-D, or —N═CH-D, in which D is selected from the group consisting of —CO-E, —SO₂-E, —N—XY, and —N⁺—XYZ, in which E may be —H, —OH, —NH₂, -R, or —OR, and X and Y and Z may be identical or different and selected from —H and -R; R being a C₁-C₁₆ alkyl, preferably a C₁-C₈ alkyl, which alkyl may be saturated or unsaturated, branched or unbranched and optionally substituted with a carboxy, sulpho or amino group; and B and C may be the same or different and selected from CₘH₂ₘ₊₁, where m=1, 2, 3, 4 or 5.

In the above mentioned general formula IV, A may be placed meta to the hydroxy group instead of being placed in the para-position as shown.

In particular embodiments of the invention the oxidizable substrate is selected from the group having the general formula V:

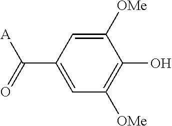

in which A is a group such as —H, —OH, —CH₃, —NH₂, —OCH₃, —O(CH₂)ₙCH₃, where n =1, 2, 3, 4, 5, 6, 7 or 8.

Yet another group of preferred oxidizable substrates are the compounds as described in general formula VI:

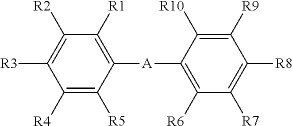

in which general formula A represents a single bond, or one of the following groups: (—CH₂—), (—CH=CH—), (—NR11—), (—CH═N—), (—N═N—), (—CH═N—N=CH—), or (>C═O);

and in which general formula the substituent groups R1-R11, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R12; and which C₁₋₈-alkyl group may be saturated or unsaturated, branched or unbranched, and may furthermore be unsubstituted or substituted with one or more substituent groups R12;

which substituent group R12 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

and in which general formula R5 and R6 may together form a group -B-, in which B represents a single bond, one of the following groups (—CH₂—), (—CH=CH—), (—CH=N—); or B represents sulfur, or oxygen. In particular embodiments of the invention the oxidizable substrate is selected from the group having the general formula VII:

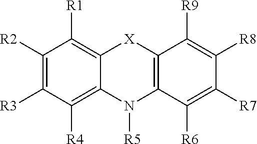

in which general formula X represents a single bond, oxygen, or sulphur;

and in which general formula the substituent groups R1-R9, which may be identical or different, independently represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, C₁₋₈-alkyl;

which carbamoyl, sulfamoyl, phenyl, and amino groups may furthermore be unsubstituted or substituted once or twice with a substituent group R10; and which C₁₋₈-alkyl group may be saturated or unsaturated, branched or unbranched, and may furthermore be unsubstituted or substituted with one or more substituent groups R10;

which substituent group R10 represents any of the following radicals: hydrogen, halogen, hydroxy, formyl, acetyl, carboxy and esters and salts hereof, carbamoyl, sulfo and esters and salts hereof, sulfamoyl, methoxy, nitro, amino, phenyl, or C₁₋₈-alkyl; which carbamoyl, sulfamoyl, and amino groups may furthermore be unsubstituted or substituted once or twice with hydroxy or methyl.

According to the invention, the oxidizable substrate may be present in a concentration in the range of from 0.01 mM to 1000 mM, preferably in the range of from 0.05 mM to 500 mM, more preferably in the range of from 0.1 mM to 100 mM, and most preferably in the range of from 0.1 mM to 50 mM.

### Methods and Uses

In a first aspect, the present invention provides a method for removing selenocyanate or selenite from an aqueous solution containing selenocyanate or selenite, comprising contacting the aqueous solution with a phenol oxidizing enzyme and an oxidizing agent required by the phenol oxidizing enzyme. Preferably, the method is a method for removing selenocyanate from an aqueous solution containing selenocyanate.

In an embodiment, the aqueous solution contains one or more oxidizable substrates, which act as electron donors and/or acceptors for the phenol oxidizing enzyme. Preferably, the oxidizable substrates act as electron donors for the phenol oxidizing enzyme. More preferably, the oxidizable substrates are phenols or polyphenols.

In another embodiment, the phenol oxidizing enzyme is laccase and the oxidizing agent is oxygen. Preferably, the amino acid sequence of the laccase has at least 80% identity to SEQ ID NO:1.

In another embodiment, the phenol oxidizing enzyme is peroxidase and the oxidizing agent is hydrogen peroxide.

In another embodiment, the method of the invention results in formation of elemental selenium, a Se(VI) salt, such as selenate, and/or organoselenium compounds.

In another embodiment, the aqueous solution is an industrial effluent or waste water or process water. The aqueous solution may be process water from hydrocarbon processing industry, such as “sour water”, “stripped sour water” or “sour water stripper bottoms” generated during refining of crude. The aqueous solution may also be an effluent from a flue gas desulphurization unit, treating, for example, flue gas released during the combustion of fossil fuel at a power plant.

As described above, the phenol oxidizing enzyme and the oxidizing agent required by the phenol oxidizing enzyme may be used for removing selenocyanate or selenite from an aqueous solution. Preferably, the phenol oxidizing enzyme is a laccase and the oxidizing agent is oxygen or a source of oxygen.

The scope of the invention includes contacting industrial effluents with phenol oxidizing enzymes by way of direct addition of enzymes at one or more points within existing operations with or without various degrees of modification. In addition, the invention is applicable to systems or stages, specifically designed to enable contact between enzymes and the effluents, may be designed or adopted and incorporated into existing operations.

Preferred conditions for the methods of the invention are those considered suitable for enabling and maintaining enzyme activity within the industrial effluent of choice. Such conditions preferably include temperatures between 30° C. and 80° C., more preferably 40° C. and 70° C., and even more preferably 40° C. and 60° C. The ideal pH range is 5 to 9, more preferably 5.5 to 8.5, more preferably 6 to 8.3 more preferably 6 to 8, and most preferably 6 to 7. Suitable contact (i.e. residence) time between the phenol oxidizing enzyme and the effluent depends on a number of factors including substrate/inhibitor levels, temperature and pH. It is expected that measureable impact on levels of one or more selenium species, such as selenocyanate or selenite, can be obtained with contact time of 15 minutes to 24 hours. The preferred dose of phenol oxidizing enzyme within the invention is 0.12-120.5 mg per liter of effluent, more preferably 0.12-12.5 mg per liter of effluent, and even more preferably 0.12-1.25 mg per liter of effluent.

Application within Specific Industries

The current invention describes a method in which industrial effluents, containing one or more selenium species (for example selenocyanate or selenite), are contacted with phenol oxidizing enzymes, in such a way that the levels of one or more of the selenium species (such as selenocyanate or selenite) are reduced. While not inclusive, such industries include hydrocarbon processing, power, mining and agriculture.

The hydrocarbon processing industry includes crude oil refining operations in which several options are available for the current invention since the process of refining crude oil results in the formation of several aqueous effluents. One effluent in particular, termed “sour water”, is comprised primarily of condensed vapor & steam generated during one or more unit operations within the refinery (e.g. distillation, hydrodesulfurization, cracking units, etc.). The sour water may be rich in ammonia, cyanide, phenol, hydrogen sulfide and selenium. The concentration of one or more of these components of sour water is typically reduced by various techniques such as steam stripping in which the sour water is cascaded downwards through an upward sweep of steam. The steam stripped effluent is more commonly known as stripped sour water. Although the stripper operation is often conducted for maximum removal of ammonia and hydrogen sulfide, certain selenium species within the sour water are not effectively removed and so high levels persist within the stripped sour water. Therefore, in one embodiment of the invention, sour water is contacted with phenol oxidizing enzymes before and/or after stripping. In a more preferred embodiment, enzymes and, if necessary, the preferred oxidizing substrates (e.g. O₂, H₂O₂, etc.) or their precursors, are added directly to storage tanks before and after the stripper.

In the hydrocarbon-based power industry, combustion of coal and other fossil fuels within power plants results in the production of exhaust gas (i.e. flue gas). During combustion, sulfur within the incoming fuels is converted to sulfur dioxide which is entrained within the flue gas. Most fossil fuel-based power plants must, therefore, incorporate a flue gas desulfurization (FGD) unit to scrub the outgoing flue gas with reagents capable of reacting with and thereby sequestering sulfur in a more manageable side-stream. Aqueous FGD effluent is generally treated with a dedicated system to remove the entrained sulfur and other compounds and, thereby, enable water reuse and/or release. When selenium is present within fossil fuels, the FGD effluent contains selenium species. Therefore, in one embodiment, the current invention may be applied at one or more places within conventional and emerging FGD effluent treatment technologies.

Water use during the mining of certain ores (e.g. Au, Cu, U) and fossil fuels (e.g. coal) containing selenium results in the mobilization of one or more selenium species into the various effluents, including leachates, unique to each operation. In most cases, steps are taken to collect the effluents for collective treatment to remove various substances within contained systems. In many instances, these systems cannot adequately address one or more species of selenium. In one embodiment, the invention describes the incorporation of enzymes and, if necessary, oxidizing and reducing substrates, into the existing systems specifically for selenium mitigation.

In another embodiment, the current invention is coupled with one or more conventional & emerging selenium mitigation technologies designed to remove one or more selenium species from relevant industrial effluents. In certain instances, limitations of the current & emerging technologies may be assuaged by the claimed invention. In one example, biological selenium removal systems are often susceptible to toxic shock when one or more effluent components are present and/or are in high concentration. Many of these toxic compounds are suitable substrates for the phenol oxidizing enzymes described in the invention. Therefore, not only does the invention reduce the toxicity of the effluent to biological selenium removal systems but it may also address a certain amount of one or more selenium species prior to the system. In another system, co-precipitation of selenium in industrial effluents with additives (e.g. iron hydroxides) may be practiced. Many times these systems are selective for certain selenium species while other species (e.g. SeCN—) resist precipitation. The current invention may extend these systems to address multiple selenium species within the effluent.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description.

Such modifications are also intended to fall within the scope of the appended claims. In the case of conflict, the present disclosure including definitions will control.

Various references are cited herein, the disclosures of which are incorporated by reference in their entireties.

### EXAMPLES

The amino acid sequence of Myceliophthora thermophila laccase is shown as SEQ ID NO:1

### Example 1

### Spectrophotometric Microassay to Quantify SeCN⁻: Initial Rate Method

A catalytic spectrophotometric method was used to quantify selenocyanate in aqueous matrices. All stocks and buffers were prepared according to Table 1. The analytical results from the calibration (Table 2) demonstrate that SeCN- can be quantified by this particular assay as long as the levels are within the range of the calibration standards (0.494-4.935 ppm).

TABLE 1
Stock solutions and buffers

| Reagent | Strength | | Preparation |
|---|---|---|---|
| SeCN— stock solution 1 | 1 × 10⁻² | M | Dissolved 0.1441 g of KSeCN in 100 ml MilliQ H₂O |
| | (789.6 mg Se/L) | | |
| SeCN— stock solution 2 | 1 × 10⁻⁴ | M | Diluted 1 ml of SeCN— stock solution 1 to 100 ml with |
| | (7.896 mg Se/L) | | MilliQ H₂O |
| Methyl orange (MO) | 1000 | mg/L | Dissolved 0.10 g of methyl orange (4-[4- |
| stock solution 1 | | | (dimethylaminophenylazo]benzenesulfonic acid |
| | | | sodium salt (Fluka #68250)) in 100 ml MilliQ H₂O |
| Methyl orange (MO) | 100 | mg/L | Diluted 10 ml of MO stock solution 1 to 100 ml with |
| stock solution 2 | | | MilliQ H₂O |
| Bromate stock solution | 5 × 10⁻² | M | Dissolved 0.835 g of KBrO₃ (Sigma-Aldrich #P7332) in |
| | | | 100 ml MilliQ H₂O |
| Hydrazine dichloride | 5 × 10⁻² | M | Dissolved 0.5249 g of N₂H₄•2HCl (Sigma-Aldrich |
| stock solution | | | #216208) in 100 ml MilliQ H₂O |

| | | |
|---|---|---|
| Phenol stock solution | 0.1M | Dissolved 0.9411 g (Sigma-Aldrich #P1037) in 100 ml |
| | | MilliQ H₂O |
| Glycine-HCl buffer | 0.1M | Dissolved 0.7507 g of glycine (Sigma-Aldrich #50050) |
| (pH 1.6) | | in 100 ml MilliQ H₂O. Used 1.0M HCl to adjust pH to |
| | | 1.6 |
| Sodium-Acetate Buffer | 0.4M | Diluted 1.28 g of glacial acetic acid (60 g/mol) and |
| (pH 6) | | 51.54 g of sodium acetate trihydrate (136.1 g/mol) to 1 |
| | | L with MilliQ H₂O |

SeCN— stock solution 2 was used to prepare calibration standards of 0.494 to 4.935 ppm Se (as SeCN—), in 50 mM sodium acetate (NaAc) buffer. In the wells of a standard 96-well microplate, reagents, buffers, standards and samples were added according to the procedure detailed in Table 3. Four wells were allotted for each standard and 8 wells for each sample. Four additional wells in the plate were reserved for reagent blanks (i.e. 0 ppm Se). Immediately after adding the standards, samples and reagents, the plate was sealed and incubated at 31° C. within a multiwell plate reader (without shaking). At times of 2, 4, 6, 8, 10, 12, 14, 16, 18, 20 & 30 minutes, the seal was removed and the absorbance at 507 nm was measured for all wells in the plate. The difference between the absorbance at 507 nm of each SeCN- standard and the reagent blank, at each time point, from 2 to 30 minutes, was determined and used to plot the decrease in absorbance at 507 nm as a function of time for each standard. The linear slopes for each standard were plotted as a function of SeCN- concentration within each standard. The resultant regression equation (Table 2) was used to determine the SeCN- levels, as ppm Se, in samples using slopes generated by plotting decreased absorbance, corrected against the blank, as a function of time for each sample.

TABLE 2
Analytical results from calibration

| Parameters | Result |
|---|---|
| Regression: | ΔABS₅₀₇/ΔTime = 0.0065In([Se]) + 0.0067 |
| Correlation coefficient (r²) | 0.992 |

TABLE 3
Catalytic spectrophotometric microassay procedure. After
addition of all reagents, the microwell plate was sealed
and incubated at 31° C. for 30 minutes during which
time several measurements of absorbance at 507 nm were taken
and used for both calibration and SeCN— quantification.

| Step | To wells in 96 well microwell plate, added . . . | Final strength | |
|---|---|---|---|
| 1 | 100 μl MilliQ H₂O | — | |
| 2 | 50 μl of glycine-HCl buffer (pH 1.6) | 0.02M | |
| 3 | 25 μl of the standard or sample | — | |
| 4 | 25 μl of the N₂H₄•2HCl solution | 5.0 × 10⁻³ | M |
| 5 | 25 μl of the MO solution 2 | 10.0 | mg/L |
| 6 | 25 μl of the Bromate solution | 5.0 × 10⁻³ | M |

### Example 2

Enzymatic Removal of Selenocyanate from an Aqueous Solution

Stock buffers, reagents, Millipure water and M. thermophila laccase were used to prepare 200 ml of total working volume in four 250 ml flasks according to Table 4. Teflon-coated stir bars were placed into each flask and glass wool was used to plug the necks of each flask. The flasks were then placed atop a magnetic stirring manifold submerged within a 40° C. water bath. Care was taken to ensure that the flask contents were below the water level within the bath. Tubes were inserted into each flask to enable continuous oxygen sparging throughout the incubation period. Oxygen was bubbled through millipure water prior to introduction into the samples to minimize loss of sample over time. While stirring the oxygen sparged samples, M. thermophila laccase was added to flasks 3 and 4. After 1 and 300 minutes of incubation, 1 ml aliquots were removed from each flask and immediately centrifuged for 15 minutes at 10,000 G. The resultant supernatants were filtered across 0.2 μm syringe filters. The selenocyanate concentration within the filtered supernatants was then determined using the procedure outlined in Example 1. Table 5 presents the results of the selenocyanate quantification. The results of the assay indicate that a significant reduction (p <0.05) of measureable selenocyanate is observed in samples containing phenol and laccase after 1 minute of incubation. After 300 minutes of incubation, over 70% of the selenocyanate is affected when incubated in the presence of phenol and laccase.

TABLE 4
Trial set composition

| | NaAc Buffer | SeCN | Phenol | Laccase |
|---|---|---|---|---|
| Trial # | (mM) | (ppm) | (mM) | (mg/L) |
| 1 | 50 | 1.579 | 0 | 0 |
| 2 | 50 | 1.579 | 3 | 0 |
| 3 | 50 | 1.579 | 0 | 12.5 |
| 4 | 50 | 1.579 | 3 | 12.5 |

TABLE 5
Soluble selenium levels, present as selenocyanate, determined
in filtrates after incubation in the presence or absence of
phenol and/or laccase. Initial conditions: 50 mM sodium acetate
buffer (pH 6), 1.579 ppm selenium as selenocyanate (in all trials),
3 mM phenol & 12.5 mg/L M. thermophila laccase when present.
Incubation was conducted for 300 minutes, at 40° C.,
with shaking under an oxygen purge. One ml aliquots were removed
from each treatment at times of 1 minute and 300 minutes.
The aliquots were centrifuged at 10,000 g for 15 minutes and
the supernatants were filtered across 0.2 micron syringe filters.
The previously described catalytic kinetic assay was used
to determine Se levels.

| Time | | Selenium as SeCN— | | |
|---|---|---|---|---|
| (min) | Treatment | (ppm) | Delta | P |
| 1 | Control | 1.068 ± 0.170 | N/A | N/A |
| | Phenol | 0.954 ± 0.101 | 10.7% | 0.302 |
| | Laccase | 1.068 ± 0.101 | 0.0% | 0.998 |
| | Phenol & Laccase | 0.749 ± 0.115 | 29.9% | 0.040 |
| | Control | 1.118 ± 0.109 | N/A | N/A |
| 300 | Phenol | 1.087 ± 0.105 | 2.8% | 0.689 |
| | Laccase | 0.971 ± 0.068 | 13.2% | 0.041 |
| | Phenol & Laccase | 0.331 ± 0.037 | 70.4% | 0.000 |

### Example 3

Enzymatic removal of selenocyanate from an aqueous solution
Stock buffers, reagents, Millipure water and M. thermophila laccase were used to prepare 200 ml of total working volume in five 250 ml flasks according to Table 6. Teflon-coated stir bars were placed into each flask and glass wool was used to plug the necks of each flask. The flasks were then placed atop a magnetic stirring manifold submerged within a 40° C. water bath. Care was taken to ensure that the flask contents were below the water level within the bath. Tubes were inserted into each flask to enable continuous oxygen or nitrogen sparging throughout the incubation period. Oxygen or nitrogen were bubbled through millipure water prior to introduction into the samples to minimize loss of sample over time. Oxygen was bubbled through flasks 1-4 while nitrogen was bubbled through flask 5. While stirring the sparged samples, M. thermophila laccase was added to flasks 3, 4 & 5. After 300 minutes of incubation, two 50 ml aliquots were removed from each flask. One of the aliquots from each flask was immediately centrifuged for 20 minutes at 4,000 G and the resultant supernatant decanted and filtered across a 0.2 μm syringe filter. The filtered supernatants were then frozen. The remaining 50 ml aliquot taken from each flask was frozen without centrifugation or filtration. The frozen samples were thawed and then two aliquots of each filtered across a 0.45 μm syringe filter directly into sealed autosampler vials. One vial was used for speciation analysis while the other was used for dissolved selenium analysis. Selenium speciation analysis, limited to the species selenocyanate, selenite and selenate, was conducted by ion chromatography inductively coupled plasma dynamic reaction cell mass spectrometry (IC-ICP-DRC-MS). Dissolved selenium analysis was performed by inductively coupled plasma dynamic reaction cell mass spectrometry (ICP-DRC-MS). Both analytical procedures to determine the species and/or concentration of selenium are well-known to one skilled in the art.

Table 7 presents the results of the filtrate speciation analysis and dissolved selenium quantification. The results of the assay indicate that a significant reduction of dissolved selenocyanate is observed in samples containing phenol and laccase after 300 minutes of incubation. After 300 minutes of incubation, the levels of dissolved selenocyanate are clearly reduced by the combined addition of laccase and phenol regardless of whether the flask contents are filtered before or after freezing. The significant reduction of selenocyanate when contacted by laccase and phenol relative to the control equates to a sizeable reduction of total dissolved selenium in the filtrates.

TABLE 6
Trial set composition.

| | NaAc Buffer | SeCN | Phenol | | Laccase |
|---|---|---|---|---|---|
| Trial # | (mM) | (ppm) | (mM) | Sparge | (mg/L) |
| 1 | 50 | 1 | 0 | O₂ | 0 |
| 2 | 50 | 1 | 3 | O₂ | 0 |
| 3 | 50 | 1 | 0 | O₂ | 12.5 |
| 4 | 50 | 1 | 3 | O₂ | 12.5 |
| 5 | 50 | 1 | 3 | N₂ | 12.5 |

TABLE 7
Soluble selenium species and levels determined in filtrates after
incubation in the presence or absence of phenol and/or laccase.
Initial conditions: 50 mM sodium acetate buffer (pH 6), 1 ppm Se as
selenocyanate (in all trials), 3 mM phenol & 12.5 mg/L M. thermophila
laccase when present. Incubation was conducted for 300 minutes, at
40° C., with shaking under an oxygen (O₂-rich) or nitrogen (O₂-poor)
purge. 50 ml aliquots were harvested from each flask at 300 minutes,
centrifuged at 4,000 g for 20 minutes and the supernatants were
filtered across 0.2 micron syringe filters prior to freezing. A
second 50 ml aliquot was harvested from each flask at 300 minutes and
frozen without centrifugation or filtration prior to freezing. The
former samples are referred to as “filtered” and the latter samples
as “unfiltered” (even though all samples were ultimately filtered
immediately prior to analysis by [IC]-ICP-DRC-MS).

| Trial | | | | | Unidentified | Total |
|---|---|---|---|---|---|---|
| set | | | | | selenium | dissolved |
| comp. | | Se(IV) | Se(VI) | SeCN | species | selenium |
| # | Sample ID | (ppb) | (ppb) | (ppb) | (ppb) | (ppb) |
| 1 | Control, | 32.5 | ND | 517 | 0.92 | 547 |
| | unfiltered, | | (<0.48) | | | |
| | O₂-rich | | | | | |
| 2 | Phenol, | 13.6 | ND | 629 | 3.60 | 688 |
| | unfiltered, | | (<0.48) | | | |
| | O₂-rich | | | | | |
| 3 | Laccase, | 37.1 | ND | 404 | 8.96 | 463 |
| | unfiltered, | | (<0.48) | | | |
| | O₂-rich | | | | | |
| 4 | Phenol & | 42.0 | ND | 36.3 | 16.10 | 149 |
| | Laccase, | | (<0.48) | | | |
| | unfiltered, | | | | | |
| | O₂-rich | | | | | |
| 1 | Control, | 26.8 | ND | 653 | 0.78 | 691 |
| | filtered, | | (<0.48) | | | |
| | O₂-rich | | | | | |
| 2 | Phenol, | 10.4 | ND | 489 | 7.09 | 512 |
| | filtered, | | (<0.48) | | | |
| | O₂-rich | | | | | |
| 3 | Laccase, | 34.6 | ND | 553 | 10.20 | 584 |
| | filtered, | | (<0.48) | | | |
| | O₂-rich | | | | | |
| 4 | Phenol & | 56.9 | ND | 58.4 | 16.20 | 168 |
| | Laccase, | | (<0.48) | | | |
| | filtered, | | | | | |
| | O₂-rich | | | | | |
| 5 | Phenol & | 61.1 | ND | 21.7 | 14.60 | 130 |
| | Laccase, | | (<0.48) | | | |
| | unfiltered, | | | | | |
| | O₂-poor | | | | | |
| 5 | Phenol & | 36.3 | ND | 11.5 | 8.58 | 80 |
| | Laccase, | | (<0.48) | | | |
| | filtered, | | | | | |
| | O₂-poor | | | | | |

### Example 4

Enzymatic Removal of Selenocyanate from Phenolic Stripped Sour Water
While stirring under ambient conditions, 800 ml of stripped sour water, received from a Bay area (CA, US) refinery within 24 hours of harvesting and never-frozen prior to testing, was pH adjusted using 40% H₂SO₄. At pH values of 8.3 (the ‘as received’ pH), 7.5 and pH 6, 40 ml aliquots were transferred to 50 ml Falcon™ tubes. The tubes were capped and partially submerged and incubated within a 50° C. water bath with no agitation. Tubes 19-21 were not capped to allow exposure to air during incubation. Enzyme was added according to the schedule presented in Table 8. At the specified times (Table 8), tubes were removed from the bath, centrifuged for 20 minutes at 4,000 G and the resultant supernatant decanted and filtered across a 0.45 μm syringe filter. Selenium speciation analysis, limited to the species selenocyanate, selenite and selenate, was conducted by ion chromatography inductively coupled plasma dynamic reaction cell mass spectrometry (IC-ICP-DRC-MS). Dissolved selenium analysis was performed by inductively coupled plasma dynamic reaction cell mass spectrometry (ICP-DRC-MS). Both analytical procedures to determine the species and/or concentration of selenium are well-known to one skilled in the art.
Table 9 presents the results of the filtrate speciation analysis and dissolved selenium quantification. The results of the assay indicate that a significant reduction of dissolved selenocyanate is observed in all enzymatically-treated samples after 300 minutes of incubation. Table 10 presents the enzymatically-catalyzed reduction of selenium species and total selenium as a function of enzyme dose as a percentage of the species and total selenium in an untreated sample of stripped sour water after 300 minutes of incubation. When applied to stripped sour water, adjusted to pH 6, 1.25 mg and 12.5 mg of laccase per liter removed 33% and 33% of SeCN—, respectively, after 300 minutes of incubation. When exposed to ambient air during incubation, SeCN— removal was increased to 76% and 71%, respectively.

TABLE 8
Trial set composition. Tubes 19-21

| | | Enzyme protein | Incubation time |
|---|---|---|---|
| Tube # | pH | (mg/L) | (min) |
| 1 | 8.3 | 0 | 0 |
| 2 | 8.3 | 0 | 300 |
| 3 | 8.3 | 1.25 | 300 |
| 4 | 8.3 | 12.5 | 60 |
| 5 | 8.3 | 12.5 | 120 |
| 6 | 8.3 | 12.5 | 300 |
| 7 | 7.5 | 0 | 0 |
| 8 | 7.5 | 0 | 300 |
| 9 | 7.5 | 1.25 | 300 |
| 10 | 7.5 | 12.5 | 60 |
| 11 | 7.5 | 12.5 | 120 |
| 12 | 7.5 | 12.5 | 300 |
| 13 | 6 | 0 | 0 |
| 14 | 6 | 0 | 300 |
| 15 | 6 | 1.25 | 300 |
| 16 | 6 | 12.5 | 60 |
| 17 | 6 | 12.5 | 120 |
| 18 | 6 | 12.5 | 300 |
| 19* | 6 | 0 | 300 |
| 20* | 6 | 1.25 | 300 |
| 21* | 6 | 12.5 | 300 |

*were exposed to ambient air during incubation.

TABLE 9
Soluble selenium species and levels, determined in filtrates of
phenolic stripped sour water, after incubation in the presence or
absence of laccase. When present, M. thermophila laccase was
added at 1.25 mg/L or 12.5 mg/L. Incubation was conducted for
300 minutes at 50° C. under quiescent conditions within sealed
Falcon tubes (tubes 19-21 were left unsealed and thereby exposed
to the atmosphere and passive aeration). At designated times,
tubes were centrifuged at 4,000 g for 20 minutes and the supernatants
were filtered across 0.45 micron syringe filters. The filtered
samples were sent, without freezing, for selenium speciation and
quantification by [IC]-ICP-DRC-MS.

| | | | | | | | Total |
|---|---|---|---|---|---|---|---|
| | | | Incubation | | | | dissolved |
| Tube | | | time | Se(IV) | Se(VI) | SeCN | selenium |
| # | Sample ID | pH | (min) | (ppb) | (ppb) | (ppb) | (ppb) |
| 1 | Control | 8.3 | 0 | 430 | ND | 872 | 1940 |
| 2 | Control | 8.3 | 300 | 402 | ND | 790 | 1810 |
| 3 | 1.25 mg/L | 8.3 | 300 | 358 | ND | 722 | 1740 |
| | laccase | | | | | | |
| 4 | 12.5 mg/L | 8.3 | 60 | 400 | ND | 800 | 1880 |
| | laccase | | | | | | |
| 5 | 12.5 mg/L | 8.3 | 120 | 390 | ND | 787 | 1790 |
| | laccase | | | | | | |
| 6 | 12.5 mg/L | 8.3 | 300 | 386 | ND | 767 | 1780 |
| | laccase | | | | | | |
| 7 | Control | 7.5 | 0 | 343 | ND | 888 | 1760 |
| 8 | Control | 7.5 | 300 | 343 | ND | 805 | 1700 |
| 9 | 1.25 mg/L | 7.5 | 300 | 326 | ND | 563 | 1690 |
| | laccase | | | | | | |
| 10 | 12.5 mg/L | 7.5 | 60 | 363 | ND | 594 | 1520 |
| | laccase | | | | | | |
| 11 | 12.5 mg/L | 7.5 | 120 | 365 | ND | 596 | 1550 |
| | laccase | | | | | | |
| 12 | 12.5 mg/L | 7.5 | 300 | 340 | ND | 609 | 1410 |
| | laccase | | | | | | |
| 13 | Control | 6 | 0 | 247 | ND | 697 | 1700 |
| 14 | Control | 6 | 300 | 263 | ND | 666 | 1530 |
| 15 | 1.25 mg/L | 6 | 300 | 298 | ND | 448 | 1460 |
| | laccase | | | | | | |
| 16 | 12.5 mg/L | 6 | 60 | 286 | ND | 397 | 1260 |
| | laccase | | | | | | |
| 17 | 12.5 mg/L | 6 | 120 | 279 | ND | 414 | 1260 |
| | laccase | | | | | | |
| 18 | 12.5 mg/L | 6 | 300 | 269 | ND | 449 | 1260 |
| | laccase | | | | | | |
| 19 | Control | 6 | 300 | DND | DND | 576 | DND |
| 20 | 1.25 mg/L | 6 | 300 | DND | DND | 136 | DND |
| | laccase | | | | | | |
| 21 | 12.5 mg/L | 6 | 300 | DND | DND | 165 | DND |
| | laccase | | | | | | |

ND = None detected.
DND = Did not determine.

TABLE 10
Percent change of various selenium species and total selenium, relative
to untreated controls, after 300 minutes of incubation of phenolic stripped
sour water with M thermophila laccase added at 1.25 and 12.5 mg/L.
All samples were centrifuged and filtered prior to analysis. The
contents of tubes 20 and 21 were exposed to atmospheric conditions
during the trial while the remaining tubes in the trial set remained
sealed for the duration of the incubation.

| | | | | | | Total |
|---|---|---|---|---|---|---|
| Tube | | | | | | dissolved |
| # | Sample ID | pH | Se(IV) | Se(VI) | SeCN | selenium |
| 3 | 1.25 mg/L laccase | 8.3 | −11% | NC | −9% | −10% |
| 6 | 12.5 mg/L laccase | 8.3 | −4% | NC | −3% | −2% |
| 9 | 1.25 mg/L laccase | 7.5 | −5% | NC | −30% | −1% |
| 12 | 12.5 mg/L laccase | 7.5 | −1% | NC | −24% | −17% |
| 15 | 1.25 mg/L laccase | 6 | +13% | NC | −33% | −5% |
| 18 | 12.5 mg/L laccase | 6 | +2% | NC | −33% | −18% |
| 20 | 1.25 mg/L laccase | 6 | DND | NC | −76% | DND |
| 21 | 12.5 mg/L laccase | 6 | DND | NC | −71% | DND |

NC = No change.
DND = Did not determine.

### Example 5

Spectrophotometric microassay to quantify Se+IV, Fixed time method
A catalytic spectrophotometric method was used to quantify selenite, Se (IV), in aqueous matrices. All stocks and buffers were prepared according to Table 11. The analytical results from the calibration (Table 12) demonstrate that Se (IV) can be quantified by this particular assay as long as the levels are within the range of the calibration standards (0.024-0.379 ppm).

TABLE 11
Stock solutions and buffers

| Reagent | Strength | | Preparation |
|---|---|---|---|
| Se (IV) standard 1 | 1 × 10⁻² | M | Dissolved 0.1110 g of SeO₂ to 100 ml with MQ |
| | | | water |
| Se (IV) standard 2 | 1 × 10⁻⁴ | M | Diluted 1 ml of Se (IV) standard 1 to 100 ml with |
| | | | MQ water |
| Methyl orange (MO) | 1000 | mg/L | Dissolved 0.10 g of methyl orange (4-[4- |
| stock solution 1 | | | (dimethylaminophenylazo]benzenesulfonic acid |
| | | | sodium salt (Fluka #68250)) in 100 ml MilliQ H₂O |
| Methyl orange (MO) | 100 | mg/L | Diluted 10 ml of MO stock solution 1 to 100 ml |
| stock solution 2 | | | with MilliQ H₂O |
| Bromate | 5 × 10⁻² | M | Dissolved 0.835 g of KBrO₃ (Sigma-Aldrich |
| stock solution | | | #P7332) in 100 ml MilliQ H₂O |
| Hydrazine dichloride | 5 × 10⁻² | M | Dissolved 0.5249 g of N₂H₄•2HCl (Sigma-Aldrich |
| stock solution | | | #216208) in 100 ml MilliQ H₂O |

| | | |
|---|---|---|
| Phenol | 0.1M | Dissolved 0.9411 g (Sigma-Aldrich #P1037) in |
| stock solution | | 100 ml MilliQ H₂O |
| Glycine-HCl buffer | 0.1M | Dissolved 0.7507 g of glycine (Sigma-Aldrich |
| (pH 1.6) | | #50050) in 100 ml MilliQ H₂O. Used 1.0M HCl to |
| | | adjust pH to 1.6 |
| HEPES Buffer | 0.2M | |
| (pH 7) | | |

Se (IV) standard stock solution 2 was used to prepare calibration standards of 0.023 to 0.379 ppm Se (as Se (IV)), in 100 mM HEPES buffer (pH 7). In the wells of a standard 96-well microplate, reagents, buffers, standards and samples were added according to the procedure detailed in Table 13. Four wells were allotted for each standard and 8 wells for each sample. Four additional wells in the plate were reserved for reagent blanks (i.e. 0 ppm Se). Immediately after adding the standards, samples and reagents, the plate was sealed and incubated at 30° C. within a multiwell plate reader (without shaking). After 180 minutes of incubation, the seal was removed and the absorbance at 507 nm was measured for all wells in the plate. After discounting the absorbance of the blank, the resultant regression equation (Table 12) was used to determine the Se (IV) levels, as ppm Se, in samples.

TABLE 12
Analytical results from calibration

| Parameters | Result |
|---|---|
| Regression: | ABS₅₀₇ = −0.0008([Se]) + 0.6183 |
| Correlation coefficient (r²) | 0.9973 |

TABLE 13
Catalytic spectrophotometric microassay procedure. After addition of
all reagents, the microwell plate was sealed and incubated at 30°
C. for 180 minutes at which time tha absorbances at 507 nm were taken
and used for both calibration and Se, as Se (IV), quantification.

| Step | To wells in 96 well microwell plate, added . . . | Final strength | |
|---|---|---|---|
| 1 | 100 μl Millipure H₂O | — | |
| 2 | 50 μl of glycine buffer pH 1.6 | 0.02M | |
| 3 | 25 μl of the standard or sample | — | |
| 4 | 25 μl of the N₂H₄•2HCl solution | 5.0 × 10⁻³ | M |
| 5 | 25 μl of the MO solution 2 | 10.0 | mg/L |
| 6 | 25 μl of the Bromate solution and started | 5.0 × 10⁻³ | M |
| | the timer | | |

| | | |
|---|---|---|
| 7 | Sealed the plate and incubated at 30° C. | — |
| 8 | At 180 min, recorded absorbance at 507 nm | — |

### Example 6

Enzymatic Removal of Se, as Se (IV), from an Aqueous Solution
Stock buffers, reagents, Millipure water and M. thermophila laccase were used to prepare 200 ml of total working volume in four 200 ml volumetric flasks according to Table 14. The contents of the flasks were then transferred to 250 ml flasks which were sealed with rubber stoppers and then placed within a 50° C. water bath. Care was taken to ensure that approximately 50% of the flask contents were above the water level within the bath thereby enabling some degree of agitation, even under the quiescent conditions of the water bath, due to resultant thermal motion. All flasks were allowed to incubate overnight. After the incubation, 15 ml aliquots were removed from each flask and immediately centrifuged for 15 minutes at 4,000 G. The resultant supernatants were filtered across 0.2 μm syringe filters. The Se, as Se (IV), concentration within the filtered supernatants was then determined using the procedure outlined in Example 5. Table 15 presents the results of the Se (IV) quantification. The results of the assay indicate that a significant reduction (−23%, p<0.05) of measureable Se (IV) is observed in samples containing phenol and laccase after the overnight incubation.

TABLE 14
Trial set composition

| | HEPES Buffer, | Se as Se (IV) | Phenol | Laccase |
|---|---|---|---|---|
| Trial # | pH 7 (mM) | (ppm) | (mM) | (mg/L) |
| 1 | 100 | 0.150 | 0 | 0 |
| 2 | 100 | 0.150 | 0.75 | 0 |
| 3 | 100 | 0.150 | 0 | 3.125 |
| 4 | 100 | 0.150 | 0.75 | 3.125 |

TABLE 15
Soluble selenium levels, present as Se (IV), determined in filtrates
after incubation in the presence or absence of phenol and/or laccase.
Initial conditions: 100 mM HEPES buffer (pH 7), 0.150 ppm selenium as
Se (IV) (in all trials), 0.75 mM phenol & 3.125 mg/L M. thermophila
laccase when present. Incubation was conducted overnight, at 40°
C., under quiescent conditions. 15 ml aliquots were then harvested
and centrifuged at 4,000 g for 15 minutes and the supernatants were
filtered across 0.2 micron syringe filters. The previously described
catalytic kinetic assay was used to determine Se levels.

| Time | | Selenium as Se (IV) | | |
|---|---|---|---|---|
| (min) | Treatment | (ppb) | Delta | p |
| overnight | Control (Se) | 145.53 ± 10.26 | N/A | N/A |
| | Phenol (Se, P) | 143.89 ± 8.36 | 1.1% | 0.624 |
| | Laccase (Se, L) | 134.36 ± 10.58 | 7.7% | 0.005 |
| | Phenol & Laccase | 112.56 ± 5.92 | 22.7% | 0.000 |
| | (Se, P, L) | | | |

1-15. (canceled)

16. A method for removing selenocyanate or selenite from an aqueous solution containing selenocyanate or selenite, comprising contacting the aqueous solution with a phenol oxidizing enzyme and an oxidizing agent required by the phenol oxidizing enzyme.

17. The method of claim 16, wherein the aqueous solution contains an oxidizable substrate, acting as electron donor and/or acceptor for the phenol oxidizing enzyme.

18. The method of claim 16, wherein the aqueous solution contains one or more phenols or polyphenols.

19. The method of claim 16, wherein the aqueous solution contains phenol.

20. The method of claim 16, wherein the phenol oxidizing enzyme is laccase and the oxidizing agent is oxygen.

21. The method of claim 20, wherein the laccase is a Myceliophthora thermophila laccase.

22. The method of claim 20, wherein the laccase is a Coprinopsis cinerea laccase

23. The method of claim 16, wherein the phenol oxidizing enzyme is peroxidase and the oxidizing agent is hydrogen peroxide.

24. The method of claim 16, which results in formation of elemental selenium, a Se(VI) salt, such as selenate, and/or organoselenium compounds.

25. The method of claim 16, wherein the aqueous solution is an industrial effluent or waste water or process water.

26. The method of claim 16, wherein the aqueous solution is process water from hydrocarbon processing industry, such as “sour water”, “stripped sour water” or “sour water stripper bottoms”.

27. The method of claim 16, wherein the aqueous solution is an effluent from a flue gas desulphurization unit.

28. The method of claim 16, wherein pH of the aqueous solution is in the range of 5 to 9.

29. . The method of claim 16, wherein the temperature of the aqueous solution is in the range of 30° C. to 80° C.
